(19) United States
(12) Patent Application Publication
(10) Pub. No.: US 2017/0164442 A1
(43) Pub. Date: Jun. 8, 2017

(54) Mercury-Vapor Like Lamp

(71) Applicant: Hubbell Incorporated, Shelton, CT (US)

(72) Inventor: T. Warren Weeks, JR., Simpsonville, SC (US)

(21) Appl. No.: 15/366,560

(22) Filed: Dec. 1, 2016

Related U.S. Application Data
(60) Provisional application No. 62/262,147, filed on Dec. 2, 2015.

(51) Int. Cl. H05B 33/08; F21V 23/00

(52) U.S. Cl. CPC H05B 33/0845; H05B 33/0857; F21V 23/005; F21Y 2115/10

(57) ABSTRACT

Systems, methods, and apparatus for providing a mercury-vapor like lamp are provided. In one embodiment, an light emitting diode device system can include a plurality of light emitting diode devices, each of the plurality of light emitting diode devices configured to emit light associated with a different light emission spectrum; and a conditioning circuit for controlling emission of light by the plurality of light emitting diode devices such that a combined light emission spectrum for the plurality of light emitting diode devices is similar to a light emission spectrum for a mercury-vapor lamp.

### FIELD

The present disclosure relates generally to light emitting diode (LED) systems.

### BACKGROUND

Mercury-vapor lamps have been used as light sources for a variety of purposes. Mercury-vapor lamps are gas discharge lamps that provide an electric arc through vaporized mercury to produce light. Mercury-vapor lamps can provide light associated with a light emission spectrum. The light emission spectrum of a mercury vapor-lamp can include light emission peaks at wavelengths associated with violet and blue light as well as emission peaks at wavelengths associated with green light so that the mercury-vapor lamps emit light with a bluish-green color. Some mercury-vapor lamps are used in conjunction with a phosphor coating to convert a portion of ultraviolet emissions of the mercury-vapor lamp into red light to increase the red light emission of the mercury-vapor lamp.

The unique light emission spectrum associated with mercury-vapor lamps can be used to provide aesthetically pleasing lighting in some applications, such as for illuminating plants and/or vegetation in, for instance, landscape applications. However, the use of mercury-vapor lamps has become disfavored for some applications because of the use of mercury and reduced efficiency relative to other light sources.

Light emitting diode (LED) devices are becoming increasingly used in many lighting applications and have been integrated into a variety of products, such as light fixtures, indicator lights, flashlights, and other products. LED devices can become illuminated as a result of the movement of electrons through a semiconductor material. LED lighting systems can provide increased energy efficiency, life and durability, can produce less heat, and can provide other advantages relative to traditional incandescent and fluorescent lighting systems. Moreover, the efficiency of LED lighting systems has increased such that higher power can be provided at lower cost to the consumer.

### SUMMARY

Aspects and advantages of embodiments of the present disclosure will be set forth in part in the following description, or may be learned from the description, or may be learned through practice of the embodiments.

One example aspect of the present disclosure is directed to a light emitting diode (LED) system. The system includes a plurality of LED devices. Each of the plurality of LED devices can be configured to emit light associated with a different light emission spectrum. The system can include a conditioning circuit for controlling emission of light by the plurality of LED devices such that a combined light emission spectrum for the plurality of LED devices is similar to a light emission spectrum for a mercury-vapor lamp.

Another example aspect of the present disclosure is directed to a light emitting diode (LED) system. The system includes a plurality of LED devices. The plurality of LED devices include: one or more first LED devices configured to emit light across a plurality of wavelengths in the visible light spectrum from about 400 nm to about 700 nm; one or more second LED devices configured to emit light having peak wavelengths in the range of about 400 nm to about 495 nm; one or more third LED devices configured to emit light having peak wavelengths in the range of about 550 nm to about 575 nm; and one or more fourth LED devices configured to emit light having peak wavelengths in the range of about 580 nm to about 600 nm. The system can further include a conditioning circuit for controlling emission of light by the plurality of LED devices such that a combined light emission spectrum for the plurality of LED devices has two or more of a first peak wavelength in the range of about 400 nm to about 450 nm, a second peak wavelength in the range of about 430 nm to about 490 nm, a third peak wavelength in the range of about 530 nm to about 590 nm, and a fourth peak wavelength in the range of about 550 nm to about 610 nm.

Yet another example aspect of the present disclosure is directed to a light emitting diode (LED) system. The system includes a plurality of light emitting diode (LED) devices. Each of the plurality of light emitting diode (LED) devices can be configured to emit light associated with a different light emission spectrum. The system can further include means for controlling a current provided to each of the plurality of LED devices such that a combined light emission spectrum for the plurality of LED devices is similar to a light emission spectrum for a mercury-vapor lamp.

Other example aspects of the present disclosure are directed to systems, apparatus, devices, and methods for providing a mercury-vapor like lamp using a plurality of light emitting diode devices.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an overview of an example system according to example embodiments of the present disclosure;

FIG. 2 depicts an example LED array according to example embodiments of the present disclosure;

FIG. 3 depicts an example combined emission spectrum provided by an example LED array according to example embodiments of the present disclosure.

FIG. 4 depicts an example combined emission spectrum provided by an example LED array according to example embodiments of the present disclosure.

FIG. 5 depicts an example conditioning circuit according to example embodiments of the present disclosure; and

FIG. 6 depicts an example conditioning circuit according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to an LED system that can be used to provide light similar to a mercury-vapor lamp. The system can include a plurality of LED devices. Each of the LED devices can be configured to emit light associated with a different light emission spectrum. The system can include a conditioning circuit configured to control the light emission (e.g., control the intensity of the light emission) of the plurality of LED devices such that a combined light emission spectrum of the lighting system is similar to a light emission spectrum associated with a mercury-vapor lamp., such as a clear mercury-vapor lamp or a phosphor coated mercury-vapor lamp.

For instance, in one embodiment, the LED system can include a first LED device, a second LED device, a third LED device, and a fourth LED device. The first LED device can be configured to emit light having a first emission spectrum (e.g., associated with white light). The second LED device can be configured to emit light having a third emission spectrum (e.g., associated with blue light). The third LED device can be configured to emit light having a second emission spectrum (e.g., associated with lime-green light). The fourth LED device can be configured to emit light associated having a fourth emission spectrum (e.g., amber light).

The LED system can include a conditioning circuit configured to control the driving currents provided to each of the first LED device, the second LED device, the third LED device, and the fourth LED device. The magnitude of driving current provided to each of the first LED device, the second LED device, the third LED device, and the fourth LED device can be used to control the intensity of light emitted by the LED devices such that the combined light provided by the LED devices has an emission spectrum that mimics or is similar to the emission spectrum of a mercury-vapor lamp.

In this way, the unique light emission spectrum typically associated with mercury-vapor like lamps can be provided using LED devices. As a result, desired lighting effects (e.g., illumination of plants or other vegetation) typically provided by mercury-vapor lamps can be provided using LED devices without the disadvantages typically associated with use of mercury-vapor lamps.

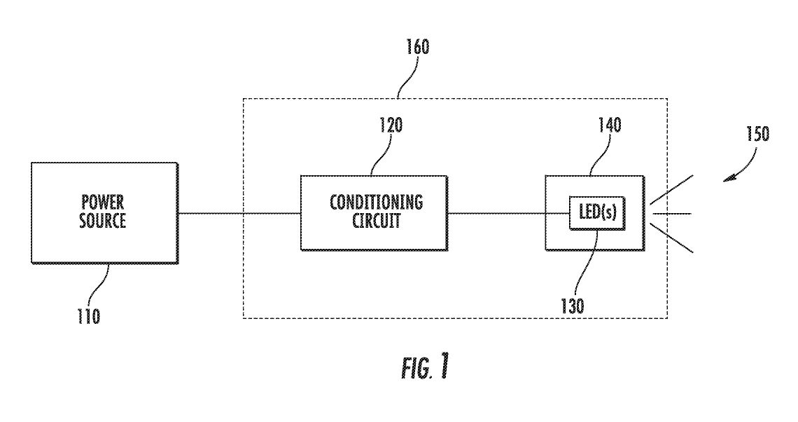

FIG. 1 depicts an overview of an example LED system 100 according to example embodiments of the present disclosure. The system 100 includes a power source 110 configured to provide power (e.g., AC power or DC power) to an LED array 130 via a conditioning circuit 120. The conditioning circuit 120 can include one or more driver circuits, current splitter circuits, current regulators, and/or other elements (e.g., resistors, variable resistors, etc.) used to control currents supplied to the one or more LED devices in the LED array 130. The currents supplied to the LED devices in the LED array 130 can be controlled so that the LED array 130 provides a light output 150 having an emission spectrum similar to a mercury-vapor lamp.

In some embodiments, the LED array 130 can be disposed in a lamp structure 140. The lamp structure 140 can take any suitable shape depending on the application of the LED system 100. In some implementations, the lamp structure 140 can be a glass or other transparent structure with one or more coatings, lenses, materials, or other elements to facilitate providing a desired light output 150 by the LED array 130. The lamp structure 140 can include a suitable connecting structure or interface for electrically connecting the LED array 130 to the conditioning circuit 120. In some embodiments, the lamp structure 140 can include the conditioning circuit 120 or at least a portion of the conditioning circuit 120 so that the lamp structure 140 can be used or connected with any suitable power source (e.g., as a part of a light fixture) to provide light output 150 having an emission spectrum similar to a mercury-vapor lamp.

In some embodiments, the LED array 130 and/or conditioning circuit 120 can be included in a light fixture 160. The light fixture 160 can include a housing used to house various components of the light fixture. The light fixture 160 can include various optics, lenses, reflectors, and other elements to provide desired lighting effects (e.g., down lighting, up lighting, accent lighting, area lighting, etc.). The light fixture 160 can include various mechanical elements to mount the light fixture 160 in a desired location (e.g., wall mount, ceiling mount, pendant mount, recessed, etc.).

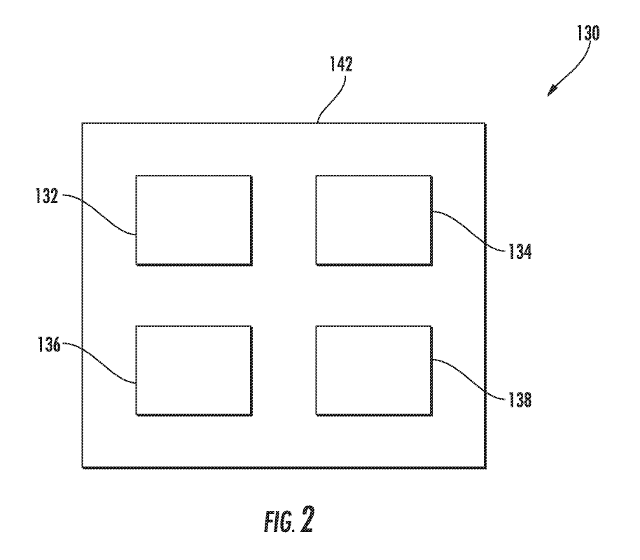

FIG. 2 depicts an example LED array 130 according to example embodiments of the present disclosure. The LED array 130 includes one or more first LED devices 132, one or more second LED devices 134, one or more third LED devices 136, and one or more fourth LED devices 138. The first LED device(s) 132, the second LED device(s) 134, the third LED device(s) 136, and the fourth LED device(s) 138 can all be located on the same circuit board 142. The distance between the LED device(s) in the LED array can be such that the light output of the LED device(s) is combined to provide a light output similar to a mercury-vapor lamp. Each of the LED devices 132, 134, 136, and 138 can be configured to emit light associated with a different emission spectrum. Four LED devices are illustrated in FIG. 2 for purposes of illustration and discussion. More or fewer LED devices can be used without deviating from the scope of the present disclosure.

In one example embodiment, the first LED device(s) 132 can be configured to emit light having an emission spectrum associated with white light (e.g., across a plurality of wavelengths in the visible light spectrum from 400 nm to 700 nm). For instance, the first LED device(s) 132 can include a phosphor converted LED device that is configured to convert light (e.g., blue light or ultraviolet light) emitted from an LED device to white light and/or can include a plurality of LED devices that are configured to produce white light by mixing red, green, and blue light. The second LED device(s) 134 can be configured to emit light having an emission spectrum associated with blue light (e.g., peak wavelengths in the range of 400 nm to 495 nm). The second LED device(s) 134 can be a standard blue LED device configured to emit blue light. The third LED device(s) 136 can be configured to emit light having an emission spectrum associated with lime-green light (e.g., peak wavelengths in the range of 550 nm to 575 nm). In some embodiments, the third LED device(s) 136 can be a phosphor converted LED device that is configured to convert light (e.g., blue light) to lime-green light. The fourth LED device(s) 138 can be configured to emit amber light (e.g., peak wavelengths in the range of 580 nm to 600 nm). For instance, the fourth LED device 138 can be a phosphor converted LED device configured to convert light (e.g., blue light or ultraviolet light) to amber light. LED devices associated with other light emission spectrums can be used without deviating from the scope of the present disclosure.

The conditioning circuit 120 of FIG. 1 can be used to control the amount of driving current provided to each of the first LED device(s) 132, the second LED device(s) 134, the third LED device(s) 136, and the fourth LED device(s) 138. The amount of current provided to the first LED device(s) 132, the second LED device(s) 134, the third LED device(s) 134, and the fourth LED device(s) 138 can control the intensity of illumination of the LED devices. In some embodiments, the currents provided to the first LED device(s) 132, the second LED device(s) 134, the third LED device(s) 136 and the fourth LED device(s) 138 are controlled so that the combined light emission spectrum of the LED array 130 is similar to that of a mercury-vapor like lamp.

As used herein, an LED array can provide a combined light emission spectrum similar to that of a mercury-vapor like lamp when the combined light emission spectrum has two or more peak wavelengths that are each within 10% of peak wavelength in a light emission spectrum associated with a mercury-vapor lamp. For instance, in one embodiment, the LED array can provide a combined light emission spectrum similar to that of a light emission spectrum associated with a clear mercury-vapor lamp. In another embodiment, the LED array can provide a combined light emission spectrum similar to a light emission spectrum associated with a phosphor coated mercury-vapor lamp.

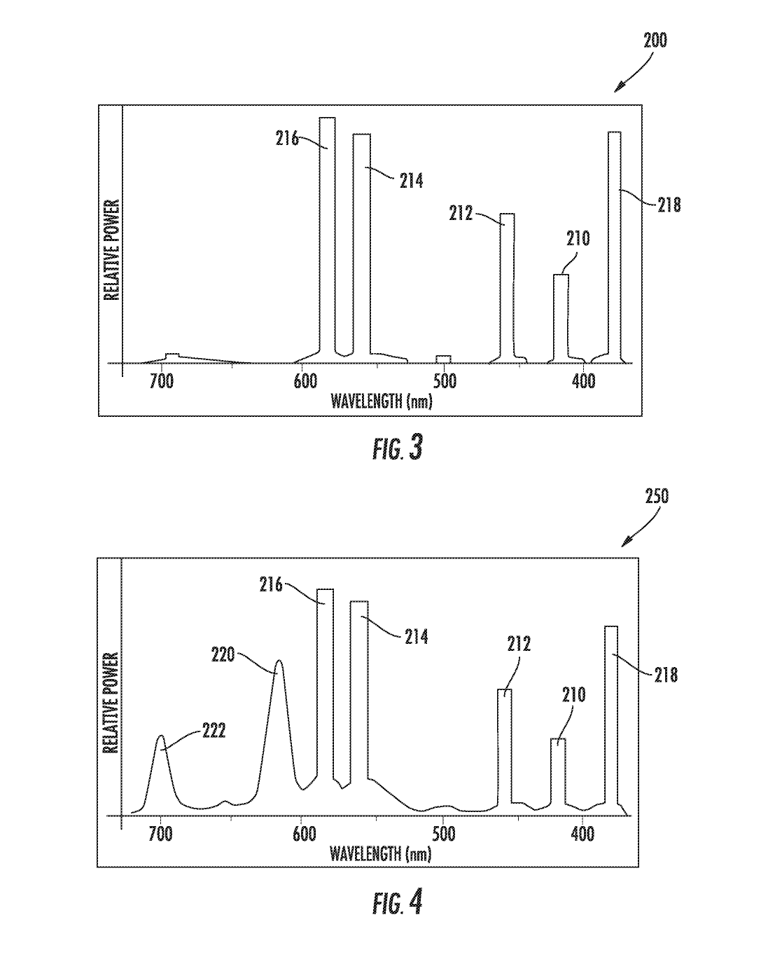

FIG. 3 depicts an example light emission spectrum 200 associated with a clear mercury-vapor lamp according to an example embodiment of the present disclosure. The example light emission spectrum 200 includes a first peak wavelength 210 in the visible spectrum in the range of about 410 nm to about 430 nm, a second peak wavelength 212 in the visible spectrum in the range of about at about 450 nm to about 470 nm, a third peak wavelength 214 in the visible spectrum in the range of about 550 nm to about 570 nm, and a fourth peak wavelength 216 in the visible spectrum in the range of about 570 nm to about 590 nm. The light emission spectrum 200 can further include a peak wavelength 218 in the range in the ultraviolet range of 300 nm to 400 nm. As used herein, the use of the term “about” in conjunction with a numerical value refers to within 5% of the state numerical value.

To provide a combined light emission spectrum similar to the light emission spectrum 200 of FIG. 3, the currents provided to each LED device in the LED array 130 can be controlled so that the LED array has a combined light emission spectrum having two or more of a first peak wavelength in the range of 400 nm to 450 nm, a second peak wavelength in the range of 430 nm to 490 nm, a third peak wavelength in the range of 530 nm to 590 nm, and a fourth peak wavelength in the range of 550 nm to 610 nm. For instance, the currents provided to each LED device in the LED array 130 can be controlled so that the LED array has a combined light emission spectrum having three or more of a first peak wavelength in the range of 400 nm to 450 nm, a second peak wavelength in the range of 430 nm to 490 nm, a third peak wavelength in the range of 530 nm to 590 nm, and a fourth peak wavelength in the range of 550 nm to 610 nm. In a particular implementation, the currents provided to each LED device in the LED array 130 can be controlled so that the LED array has a combined light emission spectrum having a first peak wavelength in the range of 400 nm to 450 nm, a second peak wavelength in the range of 430 nm to 490 nm, a third peak wavelength in the range of 530 nm to 590 nm, and a fourth peak wavelength in the range of 550 nm to 610 nm. In some embodiments, the LED array can also provide a peak wavelength in the ultraviolet range of, for instance, about 300 nm to about 400 nm.

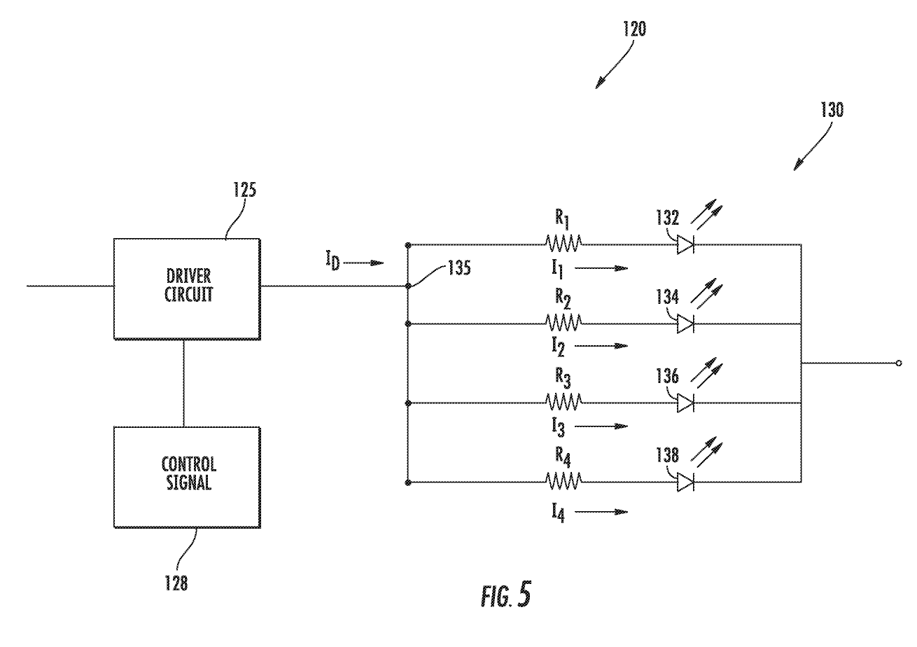

In some embodiments, the LED array 130 can be controlled to provide a combined light emission spectrum similar to that of a phosphor coated mercury-vapor lamp. FIG. 4 depicts an example an example light emission spectrum 250 associated with a phosphor coated mercury-vapor lamp according to an example embodiment of the present disclosure. Similar to the light emission spectrum 200 of FIG. 3, the example light emission spectrum 250 includes a first peak wavelength 210 in the visible spectrum in the range of about 410 nm to about 430 nm, a second peak wavelength 212 in the visible spectrum in the range of about at about 450 nm to about 470 nm, a third peak wavelength 214 in the visible spectrum in the range of about 550 nm to about 570 nm, and a fourth peak wavelength 216 in the visible spectrum in the range of about 570 nm to about 590 nm.

The light emission spectrum 250 can further include a peak wavelength 218 in the range in the ultraviolet range of 300 nm to 400 nm. In addition, the light emission spectrum can include a fifth peak wavelength in the range of about 600 nm to about 650 nm and a sixth peak wavelength in the range of about 650 nm to about 725 nm. In this way, the light emission spectrum 250 provides additional red-light emission relative to the emission spectrum 200 associated with the clear mercury-vapor lamp.

In example embodiments where the LED array 130 provides a light emission spectrum similar to an emission spectrum associated with a phosphor coated mercury-vapor lamp, the currents provided to each LED device in the LED array 130 can be controlled so that the LED array has a combined light emission spectrum having additional peak wavelengths in the range of about 600 nm to about 650 nm and/or in the range of about 650 nm to about 725 nm so that the LED array provides additional red light emission similar to a phosphor coated mercury-vapor lamp.

The LED devices in the LED array can be controlled to provide other combined light emission spectrums that are similar to a light emission spectrum associated with a mercury-vapor lamp without deviating from the scope of the present disclosure.

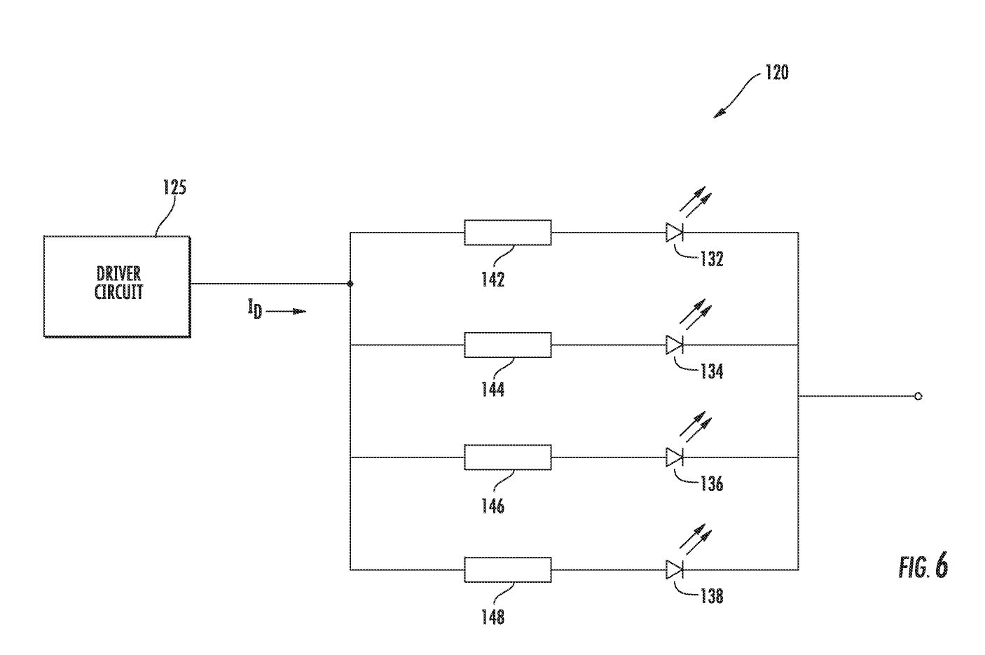

FIG. 5 depicts an example conditioning circuit 120 according to example embodiments of the present disclosure. The conditioning circuit 120 includes a driver circuit 125 configured to provide a driver current I_{D} to the LED array 130. The LED array 130 can include the first LED device(s) 132, the second LED devices(s) 134, the third LED device(s) 136, and the fourth LED device(s) 138 coupled in parallel.

The driver circuit 125 can be configured to receive an input power, such as an input AC power or an input DC power from power source 110 of FIG. 1, and can convert the input power to a suitable driver current I_{D} for powering the LED array 130. In some embodiments, the driver circuit 125 can include various components, such as switching elements (e.g. transistors) that are controlled to provide a suitable driver current I_{D}. For instance, in one embodiment, the driver circuit 125 can include one or more transistors. Gate timing commands can be provided to the one or more transistors to convert the input power to a suitable driver current I_{D} using pulse width modulation techniques. In other instances, the driver circuit 110 may be a direct drive AC circuit with full bridge rectification wherein I_{D} is a constant Irms current.

In some example embodiments, the driver circuit 125 can be dimmable driver circuit. For instance, the driver circuit 125 can be a line dimming driver, such as a phase-cut dimmable driver, Triac dimmer, trailing edge dimmer, or other line dimming driver. The driver current can be adjusted using the line dimming driver by controlling the input power to the dimmable driver circuit. In addition and/or in the alternative, the dimmable driver circuit 125 can receive a dimming control signal 128 used to control the driver current. The dimming control signal 128 can be provided from an external circuit, such as an external dimming circuit or sensor (e.g. an optical sensor, thermal sensor, or other sensor configured to provide feedback to the driver circuit for use by the driver circuit to adjust the driver current). The external circuit can include one or more devices, such as a smart dimming interface, a potentiometer, a Zener diode, or other device. The dimming control signal can be a 0V to 10V control signal or can be implemented using other suitable protocols, such as a DALI protocol, or a DMX protocol.

The driver circuit 125 can be configured to adjust the driver output based at least in part on the dimming control signal. For example, reducing the dimming control signal by 50% can result in a corresponding reduction in the driver current I_{D} of about 50%. The reduction of the driver current I_{D} for supply to the plurality of LED strings can result in the radiant flux of the LED array being decreased.

The driver current I_{D} can be split at node 135 into a current for each of the LED devices in the LED array 130. For instance, current I₁ can be provided to the first LED device(s) 132. The magnitude of the current I₁ can control the intensity of the light emitted by the first LED device(s) 132. The current I₂ can be provided to the second LED device(s) 134. The magnitude of the current I₂ can control the intensity of the light emitted by the second LED device(s) 134. The current I₃ can be provided to the third LED device(s) 136. The magnitude of the current I₃ can control the intensity of the light emitted by the third LED device(s) 134. The current I₄ can be provided to the third LED device(s) 138. The magnitude of the current I₄ can control the intensity of the light emitted by the third LED device(s) 138.

According to example embodiments, the magnitude of currents I₁, I₂, I₃, and I₄ can be controlled based on the value of the resistors R1, R2, R3, and R4 coupled in series with the first LED device(s) 132, the second LED device(s) 134, the third LED device(s) 136, and the fourth LED device(s) 138 respectively. More particularly, the value of the resistance R1 relative to the combined resistance of R1, R2, R3, and R4 can be selected control the amount of current I₁ provided to first LED device(s) 132. The value of resistance R2 relative to the combined resistance R1, R2, R3, and R4 can be selected control the amount of current I₂ provided to second LED device(s) 134. The value of resistance R3 relative to the combined resistance R1, R2, R3, and R4 can be selected control the amount of current I₃ provided to third LED device(s) 136. The value of resistance R4 relative to the combined resistance R1, R2, R3, and R4 can be selected control the amount of current I₄ provided to fourth LED device(s) 138. In this way, the value of resistances R1, R2, R3, and R4 can be selected such that the combined light emission spectrum of the LED array 130 is similar to that of a mercury-vapor lamp according to example embodiments of the present disclosure.

In some embodiments, the resistors R1, R2, R3, and R4 can be variable resistors. The resistance value of the variable resistors can be adjusted using a suitable interface (e.g., a control signal or manual interface) to provide desired currents to the first LED device(s) 132, the second LED device(s) 134, the third LED device(s) 136, and the fourth LED device(s) 138 so that the combined light output of the LED array 130 is similar to that of a mercury-vapor lamp.

FIG. 6 depicts a conditioning circuit 120 according to another example embodiment. The conditioning circuit 120 is similar to the conditioning circuit 120 depicted in FIG. 5, except that the conditioning circuit 120 includes a current regulator coupled in series with each of the first LED device(s) 132, the second LED device(s) 134, the third LED device(s) 136, and the fourth LED device(s) 138. In some embodiments, each current regulator can include one or more control devices, such as one or more microcontrollers, microprocessors, logic devices, integrated circuits, or other control that can control one or more switching elements (e.g. transistors) in communication with the LED device(s) to control the constant current supplied to the LED device(s). For instance, a duty cycle of the switching elements can be controlled to adjust the constant current provided to the LED device(s). Other suitable current regulators can be used without deviating from the scope of the present disclosure.

In the embodiment of FIG. 6, a first current regulator 142 is coupled in series with the first LED device(s) 132. A second current regulator 144 is coupled in series with the second LED device(s) 134. A third current regulator 146 is coupled in series with the third LED device(s) 136. A fourth current regulator 148 is coupled in series with the fourth LED device(s) 138. In some embodiments, the conditioning circuit 120 can include a current regulator in series with selected of the LED device(s). For instance, in one embodiment, a current regulator can be coupled in series with three of the LED devices to control the amount of current provided to three of the LED devices with the remainder or balance of the driver current being provided to the fourth LED device.

According to example aspects of the present disclosure, the lighting system can include means for controlling a current provided to each of the plurality of LED devices such that a combined light emission spectrum for the plurality of LED devices is similar to a light emission spectrum for a mercury-vapor lamp. Example means for controlling a current provided to each of the plurality of LED devices can include the conditioning circuits depicted in FIGS. 5 and 6 and other suitable conditioning circuits as discussed below.

For instance, other suitable conditioning circuits can be used to control the current provided to the LED devices in the LED array 130 without deviating from the scope of the present disclosure. For instance, the conditioning circuit can include a multi-channel driver circuit configured to provide an independent and separate driver current to each of the LED devices in the LED array so that the LED array provides a combined light output similar to that of a mercury-vapor lamp. As another example, a current splitter circuit can be used to split a driver current among the LED devices in the LED array according to a programmed current ratio so that the combined light output of the LED array is similar to that of a mercury-vapor lamp.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A light emitting diode (LED) system, comprising:
a plurality of LED devices, each of the plurality of LED devices configured to emit light associated with a different light emission spectrum; and
a conditioning circuit for controlling emission of light by the plurality of LED devices such that a combined light emission spectrum for the plurality of LED devices is similar to a light emission spectrum for a mercury-vapor lamp.

2. The LED system of claim 1, wherein the plurality of light emitting diode devices comprise:
one or more first LED devices configured to emit white light;
one or more second LED devices configured to emit lime-green light;
one or more third LED devices configured to emit blue light; and
one or more fourth LED devices configured to emit amber light.

3. The LED system of claim 1, wherein the combined light emission spectrum has two or more of a first peak wavelength in the range of about 400 nm to about 450 nm, a second peak wavelength in the range of about 430 nm to about 490 nm, a third peak wavelength in the range of about 530 nm to about 590 nm, and a fourth peak wavelength in the range of about 550 nm to about 610 nm.

4. The LED system of claim 1, wherein the combined light emission spectrum has three or more of a first peak wavelength in the range of about 400 nm to about 450 nm, a second peak wavelength in the range of about 430 nm to about 490 nm, a third peak wavelength in the range of about 530 nm to about 590 nm, and a fourth peak wavelength in the range of about 550 nm to about 610 nm.

5. The LED system of claim 1, wherein the combined light emission spectrum has a first peak wavelength in the range of about 400 nm to about 450 nm, a second peak wavelength in the range of about 430 nm to about 490 nm, a third peak wavelength in the range of about 530 nm to about 590 nm, and a fourth peak wavelength in the range of about 550 nm to about 610 nm.

6. The LED system of claim 5, wherein the combined light emission spectrum has a peak wavelength in the ultraviolet range of about 300 nm to about 400 nm.

7. The LED system of claim 5, wherein the combined light emission spectrum has an additional peak wavelength in the range of about 600 nm to about 650 nm.

8. The LED system of claim 5, wherein the combined light emission spectrum has an additional peak wavelength in the range of about 650 nm to about 725 nm.

9. The LED system of claim 1, wherein the conditioning circuit comprises a resistor coupled in series with each of the plurality of LED devices, the resistance value of each resistor selected to control the current provided to each of the plurality of LED devices such that the plurality of LED devices such that a combined light emission spectrum for the plurality of LED devices is similar to a light emission spectrum for a mercury-vapor lamp.

10. The LED system of claim 1, wherein the conditioning circuit comprises a current regulator coupled in series with each of the plurality of LED devices, each current regulator configured to control the current provided to each of the plurality of LED devices such that the plurality of LED devices such that a combined light emission spectrum for the plurality of LED devices is similar to a light emission spectrum for a mercury-vapor lamp.

11. The LED system of claim 1, wherein LED system forms at least a part of a lamp structure.

12. The LED system of claim 1, wherein the plurality of LED devices are disposed on the same circuit board.

13. A light emitting diode (LED) system, comprising:
a plurality of LED devices, the plurality of LED devices comprising:
one or more first LED devices configured to emit light across a plurality of wavelengths in the visible light spectrum from about 400 nm to about 700 nm;
one or more second LED devices configured to emit light having peak wavelengths in the range of about 400 nm to about 495 nm;
one or more third LED devices configured to emit light having peak wavelengths in the range of about 550 nm to about 575 nm; and
one or more fourth LED devices configured to emit light having peak wavelengths in the range of about 580 nm to about 600 nm;
a conditioning circuit for controlling emission of light by the plurality of LED devices such that a combined light emission spectrum for the plurality of LED devices has two or more of a first peak wavelength in the range of about 400 nm to about 450 nm, a second peak wavelength in the range of about 430 nm to about 490 nm, a third peak wavelength in the range of about 530 nm to about 590 nm, and a fourth peak wavelength in the range of about 550 nm to about 610 nm

14. The LED system of claim 13, wherein the combined light emission spectrum has three or more of a first peak wavelength in the range of about 400 nm to about 450 nm, a second peak wavelength in the range of about 430 nm to about 490 nm, a third peak wavelength in the range of about 530 nm to about 590 nm, and a fourth peak wavelength in the range of about 550 nm to about 610 nm.

15. The LED system of claim 13, wherein the combined light emission spectrum has a first peak wavelength in the range of about 400 nm to about 450 nm, a second peak wavelength in the range of about 430 nm to about 490 nm, a third peak wavelength in the range of about 530 nm to about 590 nm, and a fourth peak wavelength in the range of about 550 nm to about 610 nm.

16. The LED system of claim 13, wherein LED system forms at least a part of a lamp structure.

17. The LED system of claim 13, wherein the plurality of LED devices are disposed on the same circuit board.

18. A light emitting diode (LED) system, comprising:
a plurality of light emitting diode (LED) devices, each of the plurality of light emitting diode (LED) devices configured to emit light associated with a different light emission spectrum; and
means for controlling a current provided to each of the plurality of LED devices such that a combined light emission spectrum for the plurality of LED devices is similar to a light emission spectrum for a mercury-vapor lamp.

19. The LED system of claim 18, wherein the means for controlling a current provided to each of the plurality of LED devices comprises a conditioning circuit, the conditioning circuit comprising a resistor coupled in series with each of the plurality of LED devices, the resistance value of each resistor selected to control the current provided to each of the plurality of LED devices such that the plurality of LED devices such that a combined light emission spectrum for the plurality of LED devices is similar to a light emission spectrum for a mercury-vapor lamp.

20. The LED system of claim 18, wherein the means for controlling a current provided to each of the plurality of LED devices comprises a conditioning circuit, the conditioning circuit comprising a current regulator coupled in series with each of the plurality of LED devices, each current regulator configured to control the current provided to each of the plurality of LED devices such that the plurality of LED devices such that a combined light emission spectrum for the plurality of LED devices is similar to a light emission spectrum for a mercury-vapor lamp.
